(19) United States
(12) Patent Application Publication
(10) Pub. No.: US 2024/0345818 A1
(43) Pub. Date: Oct. 17, 2024

(54) ARTIFICIAL INTELLIGENCE MODEL INTEGRATION MANAGEMENT AND DEPLOYMENT SYSTEM AND METHOD

(71) Applicant: CONNECT SYSTEM CO., LTD., Hwaseong-si (KR)

(72) Inventor: Seung Chan BAEK, Hwaseong-si (KR)

(21) Appl. No.: 18/756,206

(22) Filed: Jun. 27, 2024

Related U.S. Application Data
(63) Continuation of application No. PCT/KR2022/020459, filed on Dec. 15, 2022.

(30) Foreign Application Priority Data
Dec. 29, 2021 (KR) 10-2021-0190620

(51) Int. Cl. G06F 8/60; G06Q 20/10

(52) U.S. Cl. CPC G06F 8/60; G06Q 20/102

(57) ABSTRACT

An artificial intelligence model integration management and deployment system includes an information management unit configured to receive user information and company information from a user terminal and code received information, an artificial intelligence model management unit configured to receive artificial intelligence model information from the user terminal, map the artificial intelligence model information to information coded by the information management unit, and optimize an artificial intelligence model according to the artificial intelligence model information to determine whether at least one of a plurality of preset processes is abnormal, a list generation unit configured to generate a list of artificial intelligence models optimized by the artificial intelligence model management unit and deploy the list to the user terminal, and a response unit configured to receive call information on the artificial intelligence model included in the list and process data on the plurality of preset processes from the user terminal.

### CROSS-REFERENCE TO RELATED APPLICATION

This application is a continuation of International Application No. PCT/KR2022/020459, filed on Dec. 15, 2022 in the Korean Intellectual Property Receiving Office, which is based on and claims priority to Korean Application No. 10-2021-0190620, filed on Dec. 29, 2021 in the Korean Intellectual Property Office, the entire disclosures of which are incorporated herein by reference.

### BACKGROUND

The present disclosure relates to an artificial intelligence model integration management and deployment system and method, and more specifically, to an artificial intelligence model integration management and deployment system and method that store and manage various artificial intelligence models for determining whether a semiconductor or display production process is abnormal and deploy an artificial intelligence model which is suitable for the semiconductor or display production process to a user in the form of a web service.

Recently, the number of companies that introduce artificial intelligence (AI) technology to a semiconductor production process and display production process has been increased, but there is a lack of physical, human, and technical resources for introducing the artificial intelligence technology to the semiconductor production process and display production process, accordingly, many companies give up on introducing the artificial intelligence technology.

When develop an artificial intelligence model through external experts or experts in the company without giving up on introducing the artificial intelligence technology, there is a problem that it takes a lot of time to develop an artificial intelligence model because there is no environment for collaboration between developers and sharing the artificial intelligence model. In addition, even when a lot of time is spent to develop the artificial intelligence model as described above, when a developer other than the developer who developed the artificial intelligence model wants to apply the artificial intelligence model to various semiconductor and display production processes, there may be a case where the artificial intelligence model is difficult to understand and may not be used.

### SUMMARY

The present disclosure provides an artificial intelligence model integration management and deployment system and method that integrate and manage artificial intelligence models for determining whether a semiconductor and display production process is abnormal and provide the artificial intelligence models in the form of a web service such that users may call the artificial intelligence models from any device and use.

In addition, the present disclosure also provides an artificial intelligence model integration management and deployment system and method that provide a shared environment where developers may develop artificial intelligence models with other developers on a team basis when developing the artificial intelligence models.

Technical problems to be solved by the present disclosure are not limited to the technical problems described above, and other technical problems of the present disclosure may be derived from following descriptions.

According to an aspect of the present disclosure, there is provided an artificial intelligence model integration management and deployment system through a communication connection with a terminal. The artificial intelligence model integration management and deployment system includes an information management unit configured to receive user information and company information from a user terminal and code received information, an artificial intelligence model management unit configured to receive artificial intelligence model information from the user terminal, map the artificial intelligence model information to information coded by the information management unit, and optimize an artificial intelligence model according to the artificial intelligence model information to determine whether at least one of a plurality of preset processes is abnormal, a list generation unit configured to generate a list of artificial intelligence models optimized by the artificial intelligence model management unit and deploy the list to the user terminal, and a response unit configured to receive call information on the artificial intelligence model included in the list and process data on the plurality of preset processes from the user terminal and provide the user terminal with response information generated based on the process data by using an artificial intelligence model corresponding to the call information.

According to another aspect of the present disclosure, there is provided an artificial intelligence model integration management and deployment method through a communication connection between a server and terminals including a user terminal and a developer terminal. The artificial intelligence model integration management and deployment method includes receiving, by the server, user information and company information from the user terminal and coding, by the server, received information, receiving, by the server, artificial intelligence model information from any one of the user terminal and the developer terminal, mapping, by the server, the artificial intelligence model information to information coded in the coding of the received information, and optimizing, by the server, an artificial intelligence model according to the artificial intelligence model information to determine whether at least one of a plurality of preset processes is abnormal, generating, by the server, a list of artificial intelligence models optimized in the optimizing of the artificial intelligence model and deploying, by the server, the list to the user terminal, and receiving, by the server, call information on the artificial intelligence model included in the list and process data on the plurality of preset processes from the user terminal and providing, by the server, the user terminal with response information generated based on the process data by using an artificial intelligence model corresponding to the call information.

### BRIEF DESCRIPTION OF THE DRAWINGS

Embodiments of the inventive concept will be more clearly understood from the following detailed description taken in conjunction with the accompanying drawings in which:

FIG. 1 is a diagram illustrating an artificial intelligence model integration management and deployment system, and terminals communicated therewith, according to an embodiment of the present disclosure;

FIG. 2 is a block diagram illustrating a configuration of the artificial intelligence model integration management and deployment system illustrated in FIG. 1;

FIG. 3 is a block diagram illustrating a configuration of the terminal illustrated in FIG. 1;

FIG. 4 is a flowchart illustrating a sequence of an artificial intelligence model integration management and deployment method according to another embodiment; and

FIGS. 5 to 7 are flowcharts illustrating detailed steps of the artificial intelligence model integration management and deployment method illustrated in FIG. 4.

### DETAILED DESCRIPTION OF THE EMBODIMENTS

Hereafter, the present disclosure will be described in detail with reference to the accompanying drawings. However, the present disclosure may be implemented in many different forms and is not limited to the embodiments described herein. In addition, the accompanying drawings are only for easy understanding of the embodiments disclosed in the present specification, and the technical ideas disclosed in the present specification are not limited by the accompanying drawings. All terms, which include technical and scientific terms and are used herein, should be construed as meanings commonly understood by those skilled in the art in the technical field to which the present disclosure belongs. Terms defined in the dictionary should be construed as having additional meanings consistent with the related technical literature and currently disclosed content, and should not be construed in a very ideal or limited sense unless otherwise defined.

In order to clearly describe the present disclosure in the drawings, parts irrelevant to the descriptions are omitted, and a size, a shape, and a form of each component illustrated in the drawings may be variously modified. The same or similar reference numerals are assigned to the same or similar portions throughout the specification.

Suffixes “module” and “unit” for the components used in the following description are given or used interchangeably in consideration of case of writing the specification, and do not have meanings or roles that are distinguished from each other by themselves. In addition, in describing the embodiments disclosed in the present specification, when it is determined that a detailed descriptions of related known technologies may obscure the gist of the embodiments disclosed in the present specification, the detailed descriptions are omitted.

Throughout the specification, when a portion is said to be “connected (coupled, in contact with, or combined)” with another portion, this includes not only a case where it is “directly connected (coupled, in contact with, or combined)”, but also a case where there is another member therebetween. In addition, when a portion “includes (comprises or provides)” a certain component, this does not exclude other components, and means to “include (comprise or provide)” other components unless otherwise described.

Terms indicating ordinal numbers, such as first and second, used in the present specification are used only for the purpose of distinguishing one component from another component and do not limit the order or relationship of the components. For example, the first component of the present disclosure may be referred to as the second component, and similarly, the second element may also be referred to as the first component. As used herein, singular forms of expression should be construed to also include plural forms of expression, unless the contrary is clearly indicated.

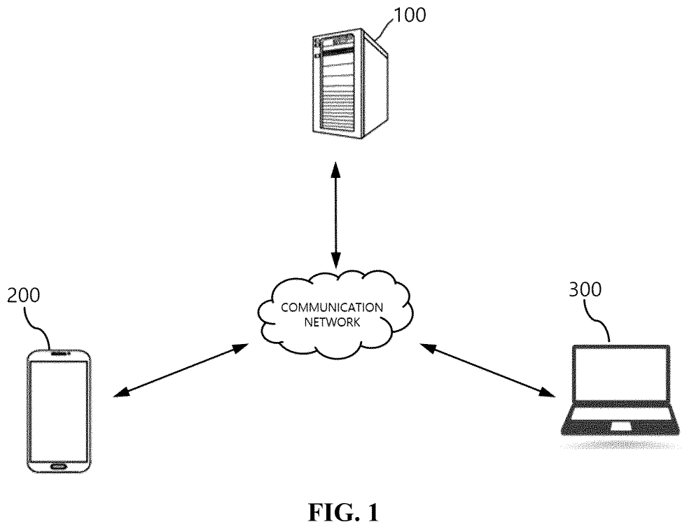

FIG. 1 illustrates a communication connection between an artificial intelligence model integration management and deployment system (hereinafter referred to as an “artificial intelligence integration management system 100”) and terminals 200 and 300 connected to the artificial intelligence integration management system 100, according to an embodiment.

Referring to FIG. 1, the artificial intelligence integration management system 100 and the terminals 200 and 300 may be interconnected to each other through a wired or wireless communication network. The artificial intelligence integration management system 100 may be implemented by a cloud computing server, such as software as a service (SaaS), platform as a service (PaaS), or infrastructure as a service (IaaS). Each of the terminals 200 and 300 may include all types of handheld-based wireless communication devices, such as a laptop computer in which a web browser is stored, a desktop computer in which a web browser is stored, a wireless communication device or smartphone that guarantees portability and mobility, and a tablet personal computer (PC) including a touchpad. A communication network may be implemented by a wired network, such as a local area network (LAN), a wide area network (WAN), or a value added network (VAN), or by any type of wireless network, such as a mobile radio communication network or a satellite communication network.

The terminals 200 and 300 may include a user terminal 200 that uses the artificial intelligence integration management system 100, and a developer terminal 300 that provides an artificial intelligence model to the artificial intelligence integration management system 100. A user using the artificial intelligence integration management system 100 may be a developer who provides an artificial intelligence model to the artificial intelligence integration management system 100. In addition, the developer who provides the artificial intelligence model to the artificial intelligence integration management system 100 may also be a user who uses the artificial intelligence integration management system 100. Accordingly, although the user terminal 200 and the developer terminal 300 are illustrated separately in FIG. 1, the user terminal 200 and the developer terminal 300 may have substantially the same configuration. The user terminal 200 may output an artificial intelligence model list and response information received from the artificial intelligence integration management system 100 and display the artificial intelligence model list and response information on a display.

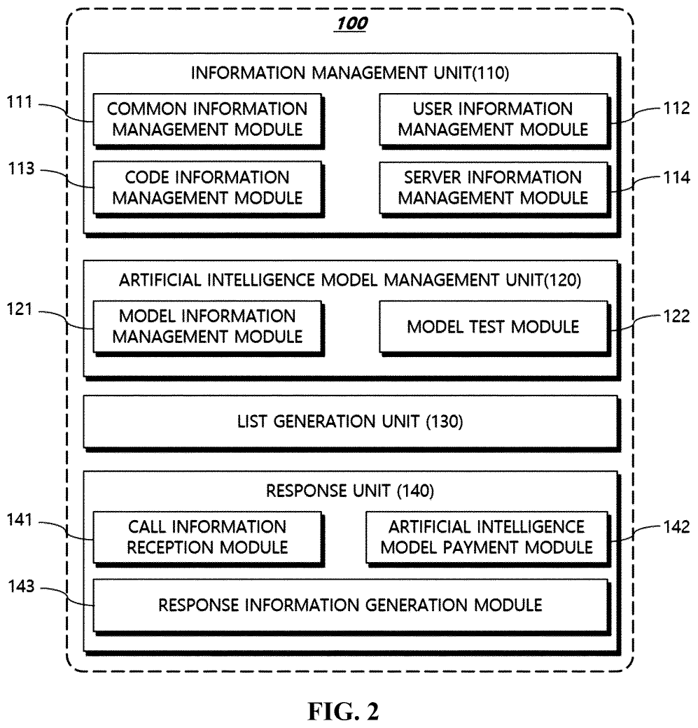

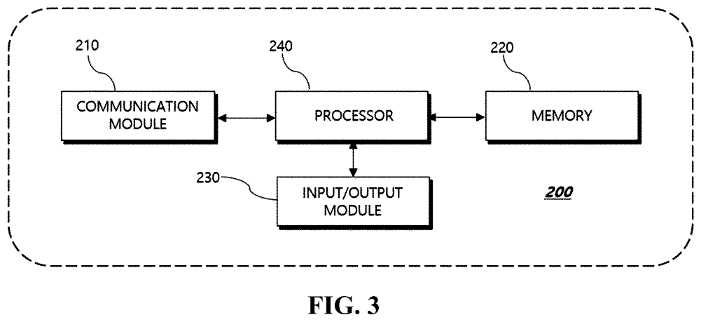

The artificial intelligence integration management system 100 and the user terminal 200 are described below in more detail with reference to FIGS. 2 and 3. The developer terminal 300 may also have substantially the same configuration as the user terminal 200 described below.

FIG. 2 is a block diagram illustrating a configuration of the artificial intelligence integration management system 100.

Referring to FIGS. 1 and 2 together, the artificial intelligence integration management system 100 may include an information management unit 110, an artificial intelligence model management unit 120, a list generation unit 130, and a response unit 140. The information management unit 110, the artificial intelligence model management unit 120, the list generation unit 130, and the response unit 140 of the artificial intelligence integration management system 100 may transmit and receive information to and from the terminals 200 and 300 through representational state transfer (REST) application program interface (API).

The information management unit 110 may receive user information and company information from the user terminal 200 and code the received information. More specifically, the information management unit 110 may include a common information management module 111, a user information management module 112, a code information management module 113, and a server information management module 114.

The common information management module 111 may receive and store company information including a company name, main business information, factory information, and process information from the user terminal 200. The process information may include at least one of semiconductor process information and display process information. The semiconductor process information may include at least one of a semiconductor production process line, a semiconductor yield test line, and semiconductor production equipment information. The display process information may include at least one of a display production process line, a display yield test line, and display production equipment information.

The user information management module 112 may receive user information from the user terminal 200 and store the user information. The user information may include at least one of a user name, a user identification (ID), a user company, a user age, a user gender, a user identification number, a user email, and a user phone number. A user's unique number may be the user's employee number or resident registration number.

The code information management module 113 may code and manage pieces of information received by the common information management module 111 and the user information management module 112. Coding may be coding the information received from the common information management module 111 and the user information management module 112 into a company code, a company main business code, and a process code. The process codes may be subdivided into process line codes, yield test line codes, production equipment codes, and process area codes.

The artificial intelligence model management unit 120 receives artificial intelligence model information from the user terminal 200 and maps the artificial intelligence model information to the information coded by the information management unit 110. The artificial intelligence model management unit 120 optimizes the artificial intelligence model according to the artificial intelligence model information to determine whether at least one of a plurality of preset processes is abnormal. More specifically, the artificial intelligence model management unit 120 may include a model information management module 121 and a model test module 122. The user terminal 200 may be the developer terminal 300.

The model information management module 121 may receive the artificial intelligence model information from the user terminal 200, map the artificial intelligence model information to the information coded by the information management unit 110, and store the mapped information. The artificial intelligence model information may include at least one of developer information on the artificial intelligence model, model name information, model version information, model content information, model input data format, and SavedModel file binary information. The model information management module 121 may classify the artificial intelligence model included in the artificial intelligence model information as a model under development or a model of which development is completed and store the classified model. The model information management module 121 may receive setting information for setting the artificial intelligence model information received from the user terminal 200 or the developer terminal 300.

The setting information described above may include at least one of whether to disclose adjustable parameter information, whether to disclose a model source, model test authority information, and whether to delete a model when learning an artificial intelligence model. The model test authority information may be information on selecting whether to provide a model modification authority of the model test module 122 only to the user terminal 200 or to a plurality of user terminals 200. For example, authority information is information on setting authority as to whether to check and test the artificial intelligence model information for each individual or for each group. Accordingly, a user may designate and manage which process the artificial intelligence model included in the artificial intelligence model information is suitable for, and check and test the artificial intelligence model information individually or in groups.

The model test module 122 receives test information corresponding to the artificial intelligence model information from the user terminal 200 and performs an accuracy test of the artificial intelligence model based on the test information. The test information may include model test data and a test answer value. When a result value of the accuracy test is less than or equal to a preset value, the model test module 122 transmits artificial intelligence model modification request information to the user terminal 200 and receives artificial intelligence model modification information from the user terminal 200. The preset value may be a similarity value derived by comparing the result value of the accuracy test with the test answer value of the test information.

The artificial intelligence model modification information may be a modified artificial intelligence model. In addition, the artificial intelligence model modification information may be data and procedure information for modifying the artificial intelligence model. The artificial intelligence model integration management system 100 may modify the existing artificial intelligence model based on the artificial intelligence model modification information.

For example, the model test module 122 checks the similarity value by comparing the result value of the accuracy test with the test answer value of the test information, and when the similarity value is 90% or less, the model test module 122 may transmit the artificial intelligence model modification request information to the user terminal 200. The model test module 122 may receive model modification information from the user terminal 200 and modify the artificial intelligence model by applying the model modification information to the artificial intelligence model. The model modification information may include at least one of parameter modification information, error correction information, and hyperparameter information. The model test module 122 may measure a second similarity value by performing a second test on the modified artificial intelligence model. When the second similarity value is 90% or less, the model test module 122 may transmit secondary modification request information to the user terminal 200, receive the secondary model modification information from the user terminal 200, and generate an artificial intelligence model. When the second similarity value is greater than 90%, the model test module 122 may provide a model modification completion alarm to the user terminal 200. The model test module 122 may store and manage both the process and result of the accuracy test. Accordingly, the model test module 122 may optimize the artificial intelligence model for at least one process among a plurality of preset processes.

The list generator 130 may generate a list of artificial intelligence models optimized by the artificial intelligence model management unit 120 and deploy the generated list to the user terminal 200. The list may include an artificial intelligence model name, an artificial intelligence model description, process information mapped to the artificial intelligence model, artificial intelligence model deployment status information, and so on.

The response unit 140 receives call information on the artificial intelligence model included in the list and process data on a plurality of preset processes from the user terminal 200. The response unit 140 may provide the user terminal 200 with response information generated based on the process data by using an artificial intelligence model corresponding to the call information. More specifically, the response unit 140 may include a call information reception module 141, an artificial intelligence model payment module 142, and a response information generation module 143.

The call information reception module 141 may receive call information of the list and process data from the user terminal 200. The call information may include at least one of model selection information, model request terminal information, model request date information, and model request time information on an artificial intelligence model selected from the list. The process data may include line information and parameter information on at least one of a plurality of preset processes. The parameter information may include various types of data measured to record steps performed in each of the semiconductor process and display process.

The artificial intelligence model payment module 142 may transmit payment request information to the developer terminal 300 of the called artificial intelligence model. When receiving payment completion information corresponding to the payment request information from the developer terminal 300, the artificial intelligence model payment module 142 may load the called artificial intelligence model from the artificial intelligence model information management unit 120.

The response information generation module 143 may input the process data to the artificial intelligence model transmitted from the artificial intelligence model management unit 120 to generate response information including an abnormality detection result, and provide the response information to the user terminal 200. The response information may include at least one of process state information, abnormality detection processing message information, abnormality detection prediction information, abnormality detection comment information, and an abnormality detection probability value. The process state information may include at least one of process temperature information, process humidity information, and process atmosphere information on each of a semiconductor process and display process.

Referring to FIGS. 1 and 3 together, the user terminal 200 may include a communication module 210, a memory 220, an input/output module 230, and a processor 240.

The communication module 210 transmits and receives information to and from the artificial intelligence integration management system 100. The communication module 210 may include a device including hardware and software required to transmit and receive signals, such as control signals or data signals through wired or wireless connections with other network devices.

The memory 220 stores an artificial intelligence model integration management program. A name of the artificial intelligence model integration management program is set for the sake of convenience of description, and the name itself does not limit a function of the program. The memory 220 may store at least one of information and data input to the communication module 210, information and data required for functions performed by the processor 240, and data generated by the processor 240. The memory 220 may include a non-volatile storage device that continuously retain the stored information even when power is not supplied thereto and a volatile storage device that requires power to maintain the stored information. In addition, the memory 220 may perform a function of temporarily or permanently storing the data processed by the processor 240. The memory 220 may include magnetic storage media or flash storage media in addition to the volatile storage device that requires power to maintain the stored information, but the present disclosure is not limited thereto.

The input/output module 230 may receive information or data transmitted from the outside to the user terminal 200 or may output information or data held by the user terminal 200 to an external device. For example, the input/output module 230 may include a display, a touch pad, a speaker, and a microphone.

The processor 240 may include various types of devices that control and process data. The processor 240 may refer to a data processing device which is built in hardware and includes a physically structured circuit to perform functions expressed as codes or instructions included in a program. In one example, the processor 240 may include a microprocessor, a central processing unit (CPU), a processor core, a multiprocessor, an application-specific integrated circuit (ASIC), a field programmable gate array (FPGA), or so on, but the present disclosure is not limited thereto. The processor 240 is configured to execute an artificial intelligence model integration management program (hereinafter referred to as a “management program”) stored in the memory 220 to perform following functions and procedures.

The information transmitted from the processor 240 to the artificial intelligence integration management system 100 may be information input to various interfaces output through the input/output module 230. The various interfaces may be received from the artificial intelligence integration management system 100 or generated by the processor 240.

The processor 240 may transmit user information and company information to the artificial intelligence integration management system 100. More specifically, the processor 240 may output a user information and company information input interface through the input/output module 230 and transmit the user information and company information input to a corresponding interface to the artificial intelligence integration management system 100 through the communication module 210.

The processor 240 may transmit the artificial intelligence model information to the artificial intelligence integration management system 100. The processor 240 may transmit test information corresponding to the artificial intelligence model information to the artificial intelligence integration management system 100 to optimize an artificial intelligence model according to the artificial intelligence model information to determine whether abnormality of at least one of a plurality of preset processes is detected. The processor 240 receives artificial intelligence model modification request information from the artificial intelligence integration management system 100 when an accuracy test result of the artificial intelligence model is less than or equal to a preset value. The processor 240 may transmit model modification information to the artificial intelligence integration management system 100 and apply the model modification information to the artificial intelligence model. Accordingly, the artificial intelligence model may be optimized to a specific process for the user terminal 200.

The processor 240 may receive a list of the optimized artificial intelligence models from the artificial intelligence integration management system 100. The processor 240 may transmit call information on the artificial intelligence model included in the list and process data of a plurality of preset processes to the artificial intelligence integration management system 100. The processor 240 may receive response information from the artificial intelligence integration management system 100. The response information is generated based on process data by using an artificial intelligence model corresponding to the call information. The response information may include at least one of process state information, abnormality detection processing message information, abnormality detection prediction information, abnormality detection comment information, and an abnormality detection probability value. The processor 240 may receive the response information from the artificial intelligence integration management system 100 through the communication module 210 and display the response information through the input/output module 230. Accordingly, the user terminal 200 may easily determine whether the process is abnormal through the artificial intelligence integration management system 100.

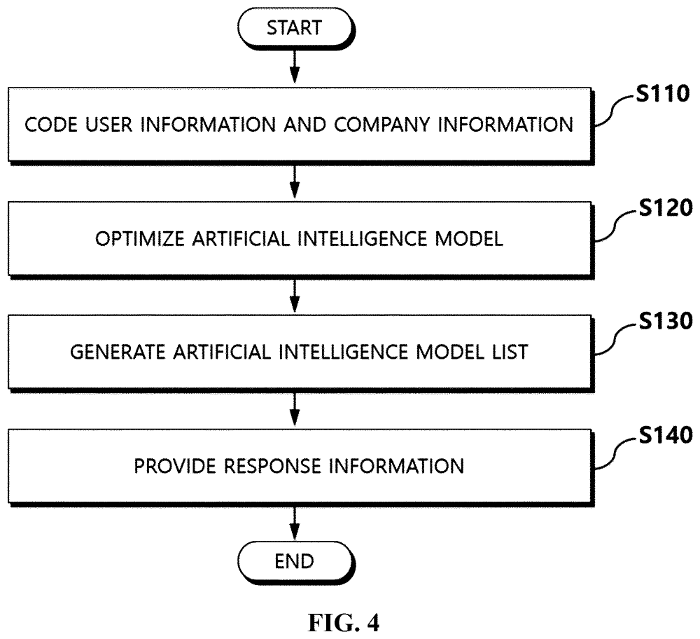

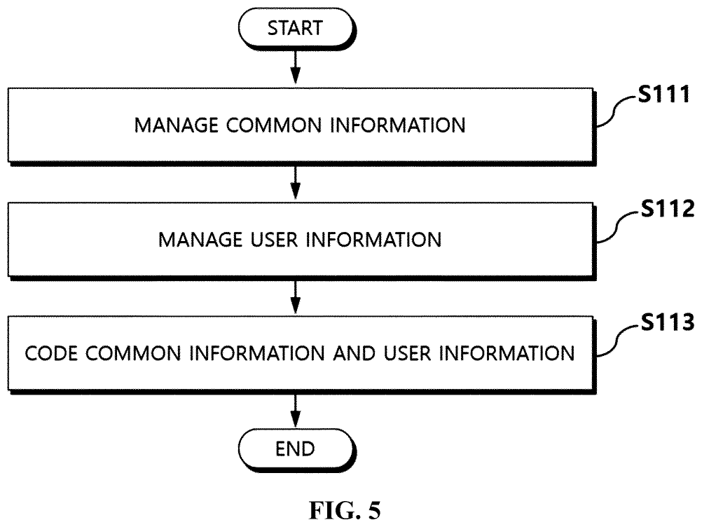

FIG. 4 is an operation flowchart illustrating an artificial intelligence model integration management and deployment method (hereinafter referred to as an “artificial intelligence model integration management method”) according to another embodiment, and FIGS. 5 to 7 are flowcharts illustrating detailed steps of the artificial intelligence model integration management method. Hereinafter, the artificial intelligence model integration management method is described with reference to FIGS. 4 to 7. Each step of the artificial intelligence model integration management method described below may be performed by at least one of the artificial intelligence integration management system 100, the user terminal 200, and the developer terminal 300 described above with reference to FIGS. 1 to 3. Therefore, the descriptions of the embodiments of the present disclosure previously given with reference to FIGS. 1 to 3 may be equally applied to the embodiments described below, and redundant descriptions thereof are omitted below. The steps described below do not necessarily have to be performed sequentially, a sequence of the steps may be set in various ways and may be performed almost simultaneously.

Referring to FIG. 4, the artificial intelligence model integration management method may be performed through a communication connection between and a server and terminals including a user terminal and a developer terminal and may include a user information and company information coding step S110, an artificial intelligence model optimization step S120, an artificial intelligence model list generation step S130, and a response information provision step S140. Here, the user terminal, the developer terminal, and the server may be respectively and substantially the same as the user terminal 200 in FIG. 1, the developer terminal 300 in FIG. 1, and the artificial intelligence model integration management system 100 in FIG. 1 described above with reference to FIGS. 1 to 3. The steps described above may be performed through REST API.

The user information and company information coding step S110 is a step in which the server receives user information and company information from the user terminal and codes the received information. In the artificial intelligence model optimization step S120, the server receives artificial intelligence model information from either the user terminal or the developer terminal, maps the artificial intelligence model information with the information coded in the user information and company information coding step S110, and optimizes an artificial intelligence model according to the artificial intelligence model information to determine whether at least one of a plurality of preset processes is abnormal. In the artificial intelligence model list creation step S130, the server generates a list of artificial intelligence models optimized in the artificial intelligence model optimization step S120 and deploys the generated list to the user terminal. The list may include an artificial intelligence model name, artificial intelligence model description, process information mapped to the artificial intelligence model, artificial intelligence model deployment status information, and so on. In the response information provision step S140, the server receives call information on the artificial intelligence model included in the list from the user terminal and process data of a plurality of preset processes, and provides response information generated based on the process data to the user terminal by using an artificial intelligence model corresponding to the call information.

Referring to FIG. 5, the user information and company information coding step (S110) may include a common information management step (S111), a user information management step (S112), and a common information and user information coding step (S113).

The common information management step (S111) is a step in which the server receives and stores a company name, main business information, and company information including factory information and process information from the user terminal. The process information may include at least one of semiconductor process information and display process information. The semiconductor process information may include at least one of a semiconductor production process line, a semiconductor yield test line, and semiconductor production equipment information. The display process information may include at least one of a display production process line, a display yield test line, and display production equipment information.

The user information management step (S112) is a step in which the server receives user information from the user terminal and stores the user information. The user information may include at least one of a user name, a user ID, a user company, a user age, a user gender, a user identification number, a user email, and a user phone number.

In the common information and user information coding step S113, the server codes and manages the information received in the common information management step S111 and the user information management step S112. The coding may be coding the information received in the common information management step S111 and the user information management step S112 into a company code, a company main business code, and a process code. The process code may be subdivided into a process line code, a yield test line code, a production equipment code, and a process area code.

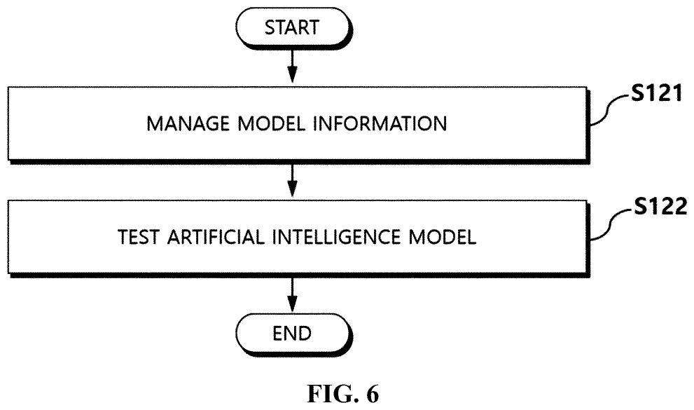

Referring to FIG. 6, the artificial intelligence model optimization step S120 may include a model information management step S121 and an artificial intelligence model testing step S122.

In the model information management step S121, the server receives artificial intelligence model information from the user terminal, maps the artificial intelligence model information to information coded by the user information and company information coding step S110, and stores the mapped information. The artificial intelligence model information may include at least one of artificial intelligence model developer information, model name information, model version information, model content information, model input data format, and SavedModel file binary information. The model information management step S121 may include a step of classifying the artificial intelligence model included in the artificial intelligence model information as a model under development or a fully developed model and store classified models. The model information management step S121 may include a step of receiving setting information for setting artificial intelligence model information provided from the user terminal or developer terminal. The setting information may include at least one of whether to disclose adjustable parameter information, whether to disclose a model source, model test authority information, and whether to delete a model when learning a model. The model test authority information may be information on selecting whether to provide model modification authority of the artificial intelligence model testing step S122 to only a corresponding user terminal or to a plurality of user terminals. For example, the model test authority information is information on setting authority for checking artificial intelligence model information for each individual and performing a test or for check the artificial intelligence model information for each group and performing the test. Accordingly, a user may designate and manage which process an artificial intelligence model included in the artificial intelligence model information is suitable for, and check and test the artificial intelligence model information individually or in groups.

In the artificial intelligence model testing step S122, the server receives test information corresponding to the artificial intelligence model information from the user terminal and performs an accuracy test of the artificial intelligence model based on the test information, and when a result of the accuracy test is less than or equal to a preset value, the server transmits artificial intelligence model modification request information to the user terminal and receives the artificial intelligence model modification information from the user terminal. The test information may include model test data and a test answer value. The preset value may be a similarity value derived by comparing the result of the accuracy test with the test answer value of the test information. For example, in the artificial intelligence model testing step S122, the server determines the similarity value by comparing the result value of the accuracy test with the test answer value of the test information, and when the similarity value is 90% or less, the server transmits the artificial intelligence model modification request information to the user terminal. In the artificial intelligence model testing step S122, the server receives model modification information from the user terminal and modifies the artificial intelligence model by applying the model modification information to the artificial intelligence model. Model modification information may include at least one of parameter modification information, error correction information, and hyperparameter information. In the artificial intelligence model testing step S122, the server measures a second similarity value by performing a second test on the modified artificial intelligence model, and when the second similarity value is 90% or less, the server transmits a second modification request to the user terminal, receives secondary model modification information from the user terminal, and modifies the artificial intelligence model. When the second similarity value is greater than 90%, a model modification completion alarm is provided to the user terminal in the artificial intelligence model testing step S122. The process and result of the accuracy test performed in the artificial intelligence model testing step S122 may be stored in the server to be managed by the server. Accordingly, in the artificial intelligence model testing step S122, the server may optimize the artificial intelligence model to at least one of a plurality of preset processes.

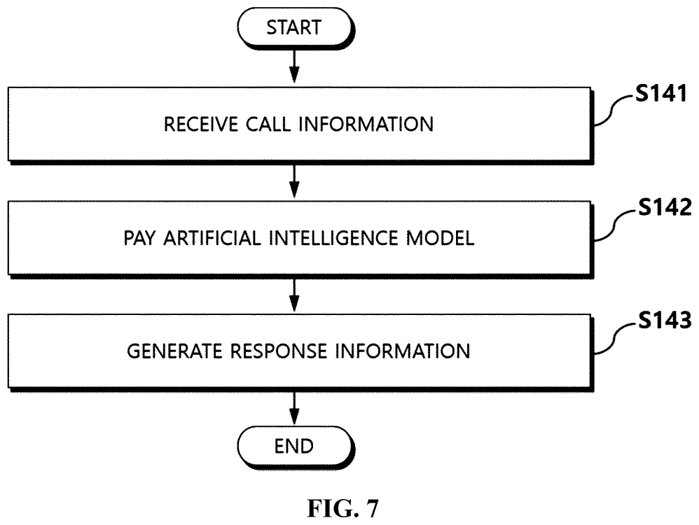

Referring to FIG. 7, the response information provision step S140 may include a call information reception step S141, an artificial intelligence model payment step S142, and a response information generation step S143.

In the call information reception step S141, the server receives call information and process data on the list from the user terminal. The call information may include at least one of model selection information, model request terminal information, model request date information, and model request time information on the artificial intelligence model selected from the list. The call information may have a following format, for example, a REST API scheme.

POST http://host:port/models/${MODEL_NAME}[/versions/${VERSION}

The process data may include line information and parameter information on at least one of a plurality of preset processes. The parameter information may include various types of data measured to record processes performed in each of the semiconductor process and display process.

The process data may have a following format in, for example, the REST API scheme.

```
  ″req_system″: ″MES″ <requesting terminal name>
    ″parameter_name″:″voltage″ <analysis request parameter name>
    ″inputs″: [{′time′:′2021-12-09 11:01:01′, ′value′:1.235},
      {′time′:′2021-12-09 11:01:02′, ′value′:1.56},
      {′time′:′2021-12-09 11:01:03′, ′value′:1.37},
      {′time′:′2021-12-09 11:01:04′, ′value′:2.5}, ] <Form of
      transmitting data
including multiple values of time and parameter information in
Json format>″
```

In the artificial intelligence model payment step S142, the server transmits payment request information to the developer terminal 300 including the called artificial intelligence model, and when receiving payment completion information corresponding to the payment request information from the developer terminal, the server receives the called artificial intelligence model from the server the developer terminal. The artificial intelligence model may be stored in the server and managed by the server.

In the response information generation step S143, the server generates response information including an abnormality detection result by inputting the process data to the artificial intelligence model received by the server and provides the response information to the user terminal. The response information may include at least one of process state information, abnormality detection processing message information, abnormality detection prediction information, abnormality detection comment information, and an abnormality detection probability value. The process state information may include at least one of process temperature information, process humidity information, and process atmosphere information on each of the semiconductor process and display process. The response information may have a following format in, for example, a REST API scheme.

```
  ″status″:″good″, <error or good>
  ″msg″: ″″, <error or processing message string>
  ″ai_predict″ : ″Y″, <ai model execution result value: system abnormality detection unit Y
or N>
  ″ai_comment″:″voltage peak″, <ai model execution comment>
  ″ai_probability″: ″0.9″ <Probability value predicted by an ai model: the closer to 1, the
higher the probability>
```

Although not illustrated in the drawings, the artificial intelligence integration management system 100 described above may include a communication module, a processor, and a memory. The processor may be configured to perform functions and operations of the information management unit 110, artificial intelligence model management unit 120, list generation unit 130, and the response unit 140 illustrated in FIG. 2. For example, the processor may receive user information and company information from the user terminal 200 and code the received information. The processor may receive artificial intelligence model information from the user terminal 200, map the artificial intelligence model information to the coded information, and optimizes an artificial intelligence model according to the artificial intelligence model information to determine whether at least one of a plurality of preset processes is abnormal. The processor may generate a list of optimized artificial intelligence models and deploy the list to the user terminal 200. The processor receives call information on the artificial intelligence model included in the list from the user terminal 200 and process data of a plurality of preset processes, and provides response information generated based on the process data to the user terminal 200 by using an artificial intelligence model corresponding to the call information.

According to the means for solving the problems of the present disclosure described above, there may be provided a system that may integrate and manage artificial intelligence models for determining whether a semiconductor process and a display process are abnormal and may provide artificial intelligence models in the form of web services such that the artificial intelligence models may be called from any terminal to be used.

In addition, according to the present disclosure, an artificial intelligence model may be provided in the form of a web service, and a shared environment may be provided in which developers may develop artificial intelligence models with other developers on a team basis when developing artificial intelligence models.

Also, according to the present disclosure, a system may be provided which may be optimized for detecting abnormalities of a semiconductor process and a display process by managing artificial intelligence models for each individual or in groups and modifying the artificial intelligence models.

The artificial intelligence model integration management and deployment method according to the embodiments of the present disclosure described above may also be implemented in the form of a recording medium including instructions executable by a computer, such as program modules that are executed by the computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

Those skilled in the technical field to which the present disclosure belongs will be able to understand that the present disclosure may be easily transformed into another specific form without changing technical idea or essential features based on the above description. Therefore, the embodiments described above should be understood as illustrative in all respects and not limiting. The scope of the present disclosure is indicated by the patent claims described below, and all changes or modified forms derived from the meaning and scope of the claims and their equivalent concepts should be construed as being included in the scope of the present disclosure. The scope of the present disclosure is indicated by the following claims rather than the detailed description above, and the meaning and scope of the claims and all changes or modifications derived from the equivalent concepts should be interpreted as being included in the scope of the present disclosure.

### MODE FOR INVENTION

The form for implementing the present disclosure is substantially the same as the previous best form for implementing the present disclosure.

### INDUSTRIAL APPLICABILITY

The present disclosure is a technology that stores and manages various artificial intelligence models for determining whether a semiconductor or display production process is abnormal and deploys an artificial intelligence model suitable for a user's semiconductor or display production process to users in the form of a web service, and has industrial applicability because the present disclosure may be used for the semiconductor industry and the display industry.

What is claimed is:

1. An artificial intelligence model integration management and deployment system through a communication connection with a terminal, the artificial intelligence model integration management and deployment system comprising:
an information management unit configured to receive user information and company information from a user terminal and code received information;
an artificial intelligence model management unit configured to receive artificial intelligence model information from the user terminal, map the artificial intelligence model information to information coded by the information management unit, and optimize an artificial intelligence model according to the artificial intelligence model information to determine whether at least one of a plurality of preset processes is abnormal;
a list generation unit configured to generate a list of artificial intelligence models optimized by the artificial intelligence model management unit and deploy the list to the user terminal; and
a response unit configured to receive call information on the artificial intelligence model included in the list and process data on the plurality of preset processes from the user terminal and provide the user terminal with response information generated based on the process data by using an artificial intelligence model corresponding to the call information,
wherein the artificial intelligence model management unit includes a model information management module configured to receive the artificial intelligence model information from the user terminal, map the artificial intelligence model information to the coded information, and store coded information, and
the model information management module classifies an artificial intelligence model included in the artificial intelligence model information as a model under development or a model of which development is completed and store the classified model.

2. The artificial intelligence model integration management and deployment system of claim 1, wherein the information management unit includes:
a common information management module configured to receive and store company information including a company name, main business information, factory information, and process information from the user terminal;
a user information management module configured to receive and store user information including a user name, a user identification, a user company, a user age, a user gender, a user identification number, a user email, and a user phone number; and
a code information management module configured to code and manage pieces of information received by the common information management module and the user information management module.

3. The artificial intelligence model integration management and deployment system of claim 1, wherein
the artificial intelligence model management unit further includes a model test module configured to receive test information corresponding to the artificial intelligence model information from the user terminal, perform an accuracy test of the artificial intelligence model based on the test information, transmit artificial intelligence model modification request information to the user terminal when a result value of the accuracy test is less than or equal to a preset value, receive model modification information from the user terminal, and modify the artificial intelligence model by applying the model modification information to the artificial intelligence model.

4. The artificial intelligence model integration management and deployment system of claim 3, wherein
the artificial intelligence model information includes at least one of the artificial intelligence model, developer information on the artificial intelligence model, model name information, model version information, and model content information.

5. The artificial intelligence model integration management and deployment system of claim 1, wherein the response unit includes:
a call information reception module configured to receive call information of the list and the process data from the user terminal;
an artificial intelligence model payment module configured to transmit payment request information to a developer terminal of the called artificial intelligence model and load the called artificial intelligence model from the artificial intelligence model information management unit when receiving payment completion information corresponding to the payment request information from the developer terminal; and
a response information generation module configured to input the process data to the artificial intelligence model received from the artificial intelligence model management unit to generate the response information including an abnormality detection result, and provide the response information to the user terminal.

6. The artificial intelligence model integration management and deployment system of claim 5, wherein
the call information includes at least one of model selection information, model request terminal information, model request date information, and model request time information on an artificial intelligence model selected from the list,
the process data includes line information and parameter information on at least one of the plurality of preset processes, and
the response information includes at least one of process state information, abnormality detection processing message information, abnormality detection prediction information, abnormality detection comment information, and an abnormality detection probability value.

7. The artificial intelligence model integration management and deployment system of claim 1, wherein
the information management unit, the artificial intelligence model management unit, the list generation unit, and the response unit transmit and receive information to and from the user terminal through a representational state transfer application program interface (REST API).

8. An artificial intelligence model integration management and deployment method through a communication connection between a server and terminals including a user terminal and a developer terminal, the artificial intelligence model integration management and deployment method comprising:
receiving, by the server, user information and company information from the user terminal and coding, by the server, received information;
receiving, by the server, artificial intelligence model information from any one of the user terminal and the developer terminal, mapping, by the server, the artificial intelligence model information to information coded in the coding of the received information, and optimizing, by the server, an artificial intelligence model according to the artificial intelligence model information to determine whether at least one of a plurality of preset processes is abnormal;
generating, by the server, a list of artificial intelligence models optimized in the optimizing of the artificial intelligence model and deploying, by the server, the list to the user terminal; and
receiving, by the server, call information on the artificial intelligence model included in the list and process data on the plurality of preset processes from the user terminal and providing, by the server, the user terminal with response information generated based on the process data by using an artificial intelligence model corresponding to the call information,
wherein the receiving and mapping of the artificial intelligence model information includes receiving, by the server, the artificial intelligence model information from the user terminal, mapping, by the server, the artificial intelligence model information to the coded information, and storing, by the server, the mapped artificial intelligence model information, and
the receiving, mapping, and storing of the artificial intelligence model information includes classifying an artificial intelligence model included in the artificial intelligence model information as a model under development or a model of which development is completed and storing the classified model.

9. The artificial intelligence model integration management and deployment method of claim 8, wherein the receiving of the user information and the company information and the coding of the received information includes:
receiving and storing, by the server, company information including a company name, main business information, factory information, and process information from the user terminal;
receiving and storing, by the server, user information including a user name, a user identification, a user company, a user age, a user gender, a user identification number, a user email, and a user phone number; and
coding and managing, by the server, pieces of information received in the receiving and storing of the company information and the receiving and storing of the user information.

10. The artificial intelligence model integration management and deployment method of claim 8, wherein
the receiving and mapping of the artificial intelligence model information and the optimizing of the artificial intelligence model further include receiving test information corresponding to the artificial intelligence model information from the user terminal, performing an accuracy test of the artificial intelligence model based on the test information, transmitting artificial intelligence model modification request information to the user terminal when a result value of the accuracy test is less than or equal to a preset value, receiving model modification information from the user terminal, and modifying the artificial intelligence model by applying the model modification information to the artificial intelligence model.

11. The artificial intelligence model integration management and deployment method of claim 10, wherein
the artificial intelligence model information includes at least one of the artificial intelligence model, developer information on the artificial intelligence model, model name information, model version information, and model content information.

12. The artificial intelligence model integration management and deployment method of claim 8, wherein the receiving of the call information and the providing of the user terminal with the response information includes:
receiving, by the server, call information of the list and the process data from the user terminal;
transmitting, by the server, payment request information to a developer terminal of the called artificial intelligence model and loading the called artificial intelligence model from the artificial intelligence model information management unit when receiving payment completion information corresponding to the payment request information from the developer terminal; and
inputting, by the server, the process data to the artificial intelligence model received from the artificial intelligence model management unit to generate the response information including an abnormality detection result, and providing, by the server, the response information to the user terminal.

13. The artificial intelligence model integration management and deployment method of claim 12, wherein
the call information includes at least one of model selection information, model request terminal information, model request date information, and model request time information on an artificial intelligence model selected from the list,
the process data includes line information and parameter information on at least one of the plurality of preset processes, and
the response information includes at least one of process state information, abnormality detection processing message information, abnormality detection prediction information, abnormality detection comment information, and an abnormality detection probability value.

14. The artificial intelligence model integration management and deployment method of claim 8, wherein
the server transmits and receives information to and from the terminals through a representational state transfer application program interface (REST API).
